(19) United States
(12) Patent Application Publication
(10) Pub. No.: US 2026/0131251 A1
(43) Pub. Date: May 14, 2026

(54) NON-TRANSITORY COMPUTER-READABLE MEDIUM AND SYSTEM

(71) Applicant: SQUARE ENIX CO., LTD., Tokyo (JP)

(72) Inventor: Masaki NAKAGAWA, Tokyo (JP)

(73) Assignee: SQUARE ENIX CO., LTD., Tokyo (JP)

(21) Appl. No.: 19/425,750

(22) Filed: Dec. 18, 2025

(30) Foreign Application Priority Data
Nov. 8, 2024 (JP) 2024-196353

(51) Int. Cl. A63F 13/69

(52) U.S. Cl. CPC A63F 13/69

(57) ABSTRACT

One or more embodiments of the disclosure provide a non-transitory computer-readable medium storing an information processing program that, when executed, causes a server to perform: by associating a party constituted by a plurality of players with content provided in the video game, providing the content to the party; identifying at least a player who does not have a play experience of the content among players constituting the party; determining, based on the identified number of players, a benefit that is at least subject to playing the content; and rewarding the party based on the determined benefit.

### CROSS-REFERENCE TO RELATED APPLICATION

The present application claims priority to and the benefit of Japanese Patent Application No. 2024-196353 filed on Nov. 8, 2024, the disclosure of which is expressly incorporated herein by reference in its entirety for any purpose.

### BACKGROUND

### Technical Field

At least one of the embodiments of the present invention relates to a video game processing program and a video game processing system for realizing a function of controlling progress of a video game.

Conventionally, various systems for providing video games to users have been proposed.

In such a system, for example, in order to improve the play motivation of a user (that is, a player) who plays a video game, a character selected by the player is set as a growth target, and a selection item can be selected for each game section. Examples of such systems may be found in Japanese Patent Application Publication No. 2023-097761 A

### SUMMARY

However, conventional systems may not be able to provide players with sufficient motivation to play video games. That is, for example, in a case where a new stage is provided in a video game, when the difficulty level of the new stage is too high, a user who plays the video game may be limited, or when popularity is concentrated on the new stage, a user who plays the conventional stage may be reduced.

It is an object of at least one embodiment of the present invention to provide a video game processing program and a video game processing system capable of providing a player with a motivation to play a video game.

### Means for Solving the Problem

According to a non-limiting aspect, a video game processing program according to one embodiment of the present invention is a video game processing program for causing a server to realize a function of controlling the progress of a video game, the program comprising: a providing function of causing the server to provide the content to a party constituted by a plurality of players by associating the party with content provided in the video game, in order to realize a specification function of specifying at least a player who does not have a play experience of the content among players constituting the party, a determination function of determining a benefit at least on the condition of playing the content based on the number of specified players, and an awarding function of awarding a reward to the party based on the determined benefit.

According to a non-limiting aspect, a video game processing system according to one embodiment of the present invention includes a communication network, a server, and a player terminal, and is configured to perform processing for controlling progress of a video game, wherein a party composed of a plurality of players; providing means for providing the content to the party by associating the content with the content provided in the video game; an identification means for identifying at least a player who does not have a play experience of the content among players constituting the party; determining means for determining a benefit at least on the condition of playing the content based on the number of identified players; and a rewarding means for providing a reward to the party based on the determined benefit.

According to a non-limiting aspect, a video game processing program according to one embodiment of the present invention is a video game processing program for causing a player terminal to realize a function of controlling progress of a video game, the program comprising: a providing function of providing, to the player terminal, a party constituted by a plurality of players and content provided in the video game in association with each other, the content to the party, in order to realize a specification function of specifying at least a player who does not have a play experience of the content among players constituting the party, a determination function of determining a benefit at least on the condition of playing the content based on the number of specified players, and an awarding function of awarding a reward to the party based on the determined benefit.

One or more deficiencies are resolved by embodiments of the present application.

### BRIEF DESCRIPTION OF DRAWINGS

FIG. 1 is a block diagram showing an example of a configuration of a video game processing system corresponding to at least one of embodiments of the present invention.

FIG. 2 is a block diagram showing a configuration of a server corresponding to at least one of the embodiments of the present invention.

FIG. 3 is a flowchart showing an example of a game process corresponding to at least one of the embodiments of the present invention.

FIG. 4 is a flowchart showing an example of the operation on the server side in the game process corresponding to at least one of the embodiments of the present invention.

FIG. 5 is a flowchart showing an example of an operation on the terminal side in a game process corresponding to at least one of the embodiments of the present invention.

FIG. 6 is a block diagram showing a configuration of a server corresponding to at least one of the embodiments of the present invention.

FIG. 7 is a flowchart showing an example of a game process corresponding to at least one of the embodiments of the present invention.

### DETAILED DESCRIPTION

Hereinafter, an example of an embodiment of the present invention will be described with reference to the drawings. Various constituent elements in the examples of the embodiments described below can be appropriately combined within a range in which no contradiction or the like occurs. Further, description of the content described as an example of a certain embodiment may be omitted in other embodiments. Further, the contents of operations and processes not related to the characteristic portions of the embodiments may be omitted. Further, the order of various processes constituting various flows described below is not the same as long as no contradiction occurs in the contents of the processes.

### First Embodiment

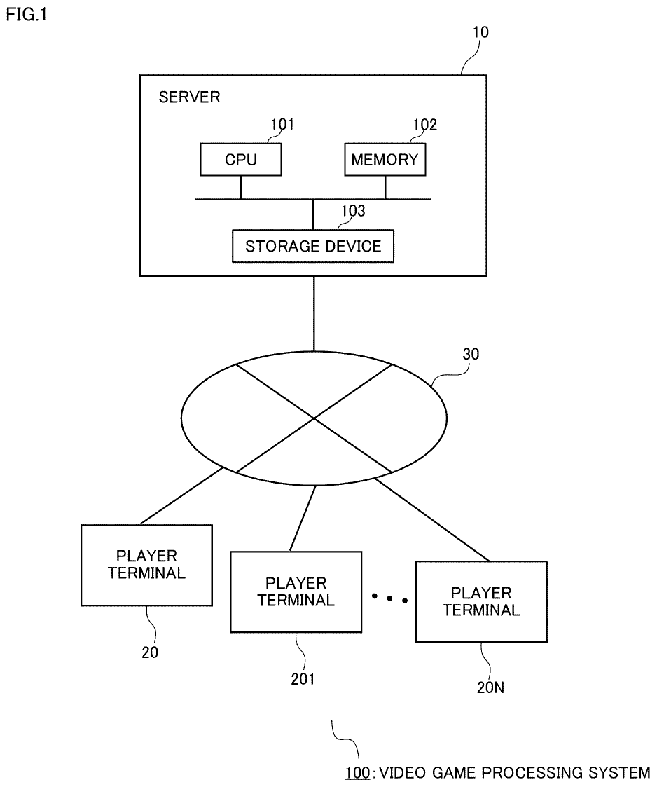

FIG. 1 is a block diagram showing an example of a configuration of a video game processing system 100 according to an embodiment of the present invention. As shown in FIG. 1, the video game processing system 100 includes a video game processing server 10 (server 10) and player terminals (player terminals) 20, 201 to 20N (N is an arbitrary integer) used by a player of the video game processing system 100. Note that the configuration of the video game processing system 100 is not limited to this, and a configuration may be adopted in which a single player terminal is used by a plurality of players, or a configuration may be adopted in which a plurality of servers is provided.

The server 10 and the plurality of player terminals 20 and 201 to 20N are connected to a communication network 30 such as the Internet. Although not shown, the plurality of player terminals 20 and 201 to 20N are connected to the communication network 30 by performing data communication with a base station managed by a communication provider via a wireless communication line.

The video game processing system 100 includes a server 10 and a plurality of player terminals 20 and 201 to 20N, thereby realizing various functions for executing various processes in accordance with an operation of a player.

The server 10 is managed by an administrator of the video game processing system 100, and has various functions for providing information related to various processes to the plurality of player terminals 20 and 201 to 20N. In the present example, the server 10 is configured by an information processing apparatus such as a WWW server, and includes a storage medium that stores various kinds of information. The configuration of the server 10 is not particularly limited as long as it includes a general configuration for performing various processes as a computer, such as a control unit and a communication unit. Hereinafter, an example of a hardware configuration of the server 10 will be briefly described.

As illustrated in FIG. 1, the server 10 includes at least CPU (Central Processing Unit)101, a memory 102, and a storage device 103.

The CPU 101 is a central processing unit that performs various calculations and controls. When the server 10 includes a GPU (Graphics Processing Unit), a part of various calculations and controls may be performed by the GPU. The server 10 causes the CPU 101 to execute various kinds of information processing necessary for controlling the video game by using the data read out to the memory 102 as appropriate, and stores the obtained processing result in the storage device 103 as necessary.

The storage device 103 has a function as a storage medium for storing various kinds of information. The configuration of the storage device 103 is not particularly limited, but from the viewpoint of reducing the processing load on each of the plurality of player terminals 20 and 201 to 20N, it is preferable to have a configuration capable of storing all the various kinds of information necessary for controlling the video game. Such examples include HDDs and SSDs. However, the storage unit that stores various kinds of information may include a storage area in a state accessible by the server 10, and may have, for example, a dedicated storage area outside the server 10.

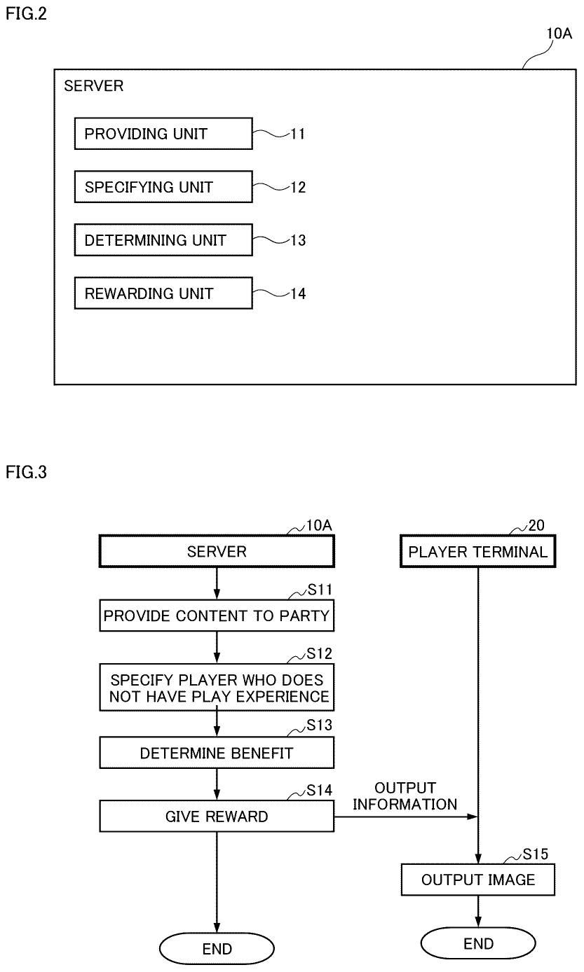

FIG. 2 is a block diagram showing a configuration of a video game processing server 10A (server 10A) which is an example of a configuration of the video game processing server 10. As illustrated in FIG. 2, the server 10A includes at least a providing unit 11, a specifying unit 12, a determining unit 13, and an rewarding unit 14.

The providing unit 11 has a function of providing content to a party constituted by a plurality of players by associating the party with content provided in a video game.

Here, the configuration for configuring the party is not particularly limited, but is preferably configured by matching a plurality of players. The party may include a so-called non-player character.

In addition, the content means various play elements that a player plays in a party. Although an example of the content is not particularly limited, it is preferable that the content can be cleared or attacked when the player achieves the task. Examples of content include so-called dungeons, battles, and discussions.

Furthermore, providing a party to content means allowing the party to play the content. The method of providing the content is not particularly limited, and the party may be moved to the virtual space for the content, or the task corresponding to the content may be set in the party.

The specifying unit 12 has a function of specifying at least a player who does not have a play experience of content among players constituting a party.

Here, a configuration for specifying a player who does not have a play experience of content is not particularly limited, but a configuration for specifying the number of players corresponding to at least a party is preferable. In an example of such a configuration, the play history of each player is referred to and identified.

The determination unit 13 has a function of determining a benefit at least on the condition that the content is played, based on the specified number of players.

Here, the configuration for determining the specification is not particularly limited, but is preferably a configuration in which the player can recognize the benefit. Examples of such a configuration include a configuration in which a benefit is determined according to a predetermined rule. Examples of the predetermined rule include a configuration in which a table in which the number of players who do not have the play experience of the content and the benefit content are associated with each other is referred to, and a configuration in which a predetermined lottery is repeated by the number.

The granting unit 14 has a function of granting a reward to a party based on the determined benefit.

Here, the configuration for giving the reward to the party is not particularly limited, but it is preferable that the party member can recognize that the reward is given. Examples of such a configuration include a configuration in which the determined benefit is directly given to each player constituting the party as a reward, and a configuration in which a reward is given to a player satisfying a specific condition.

Each of the plurality of player terminals 20 and 201 to 20N is managed by a player, and is configured by a communication terminal capable of performing a network distribution type game, such as a mobile phone terminal, PDA (Personal Digital Assistants), a mobile game apparatus, or a so-called wearable device. Note that the configuration of the player terminal that can be included in the video game processing system 100 is not limited to the example described above, and may be any configuration as long as the player can recognize the contents of the video game. Other examples of the configuration of the player terminal include a combination of various communication terminals, a personal computer, and a stationary game apparatus.

Each of the plurality of player terminals 20 and 201 to 20N includes hardware (For example, a display device that displays a browser screen or a game screen according to coordinates.) and software for performing various processes by connecting to the communication network 30 and communicating with the server 10. Each of the plurality of player terminals 20 and 201 to 20N may be configured to directly communicate with each other without using the server 10.

Next, the operation of the video game processing system 100 (system 100) of the present example will be described.

FIG. 3 is a flowchart showing an example of game processing executed by the system 100. In the game process in the present example, a process related to controlling the progress of the video game in accordance with the operation of the player of the player terminal 20 (terminal 20) is performed. Hereinafter, a case where the server 10A and the terminal 20 execute game processing will be described as an example.

The game process is started, for example, when the system 100 receives an operation input by the player.

In the game process, the server 10A first provides content to the party (step S11). In the present example, when receiving a play request specifying a content from a party constituted by a plurality of players, the server 10A provides the content to the party by associating the party with the content.

When the content is provided to the party, the server 10A specifies a player who does not have a play experience (step S12). In the present example, the server 10A specifies a player who does not have the play experience of the content and does not have the clear experience of the content among the players constituting the party.

When the player who does not have the play experience is identified, the server 10A determines a benefit (step S13). In the present example, the server 10A determines the reward to be added to the reward to be given when the party clears the content based on the number of players who do not have the clearing experience of the content among the players constituting the party. More specifically, the server 10A refers to the benefit information in which the in-game element available in the video game and the lottery probability are associated with each other, and determines the benefit by performing the lottery a number of times corresponding to the specified number of players. Examples of in-game elements include in-game currency, items, characters, and names.

Upon determining the benefit, the server 10A gives a reward (step S14). In the present example, when the party clears the content, the server 10A gives each player an in-game element as a result of adding a benefit to the reward corresponding to the clear.

When the reward is granted, the server 10A generates output information for outputting the granted result to the player terminal 20, and transmits the generated output information to the player terminal 20.

The terminal 20 displays an image based on the output information received from the server 10A (step S15).

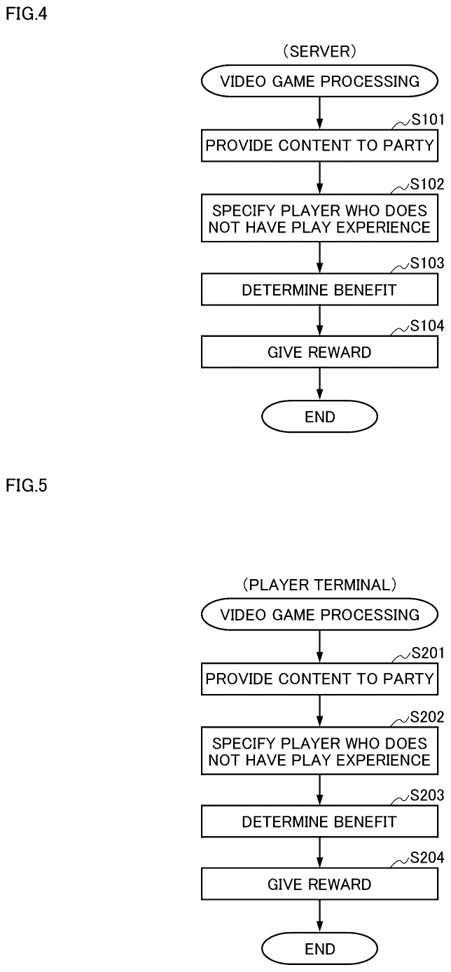

FIG. 4 is a flowchart illustrating an example of the operation of the server 10A side in the game process. Here, the operation of the server 10A in the system 100 will be described again.

In the game process, the server 10A first provides content to a party (step S101), specifies a player who does not have a play experience in the party (step S102), determines a benefit corresponding to the content and the party (step S103), and gives a reward to the party (step S104).

FIG. 5 is a flowchart illustrating an example of the operation of the terminal 20 when the terminal 20 executes the game process. Hereinafter, a case where the terminal 20 executes the game process by itself will be described as an example. Since the configuration of the terminal 20 has the same function as the configuration of the server 10 except that various kinds of information are received from the server 10, the description thereof is omitted from the viewpoint of avoiding redundant description.

In the game processing, first, the terminal 20 provides content to the party (step S201), specifies a player who does not have a play experience in the party (step S202), determines a benefit corresponding to the content and the party (step S203), and gives a reward to the party (step S204). In the present example, the terminal 20 acquires information used in each step by communicating with the server 10A. Note that the terminal 20 may be configured to specify information used in each step with reference to a storage unit included therein.

As described above, as one aspect of the first embodiment, since the server 10A that controls the progress of the video game is configured to include the providing unit 11, the specifying unit 12, the determining unit 13, and the giving unit 14, the party configured by a plurality of players and the content provided in the video game are associated with each other to provide the content to the party, and at least the player that does not have the play experience of the content among the players configuring the party is specified, based on the number of players identified as players who do not have the play experience of the content, it is possible to determine a benefit at least on the condition of playing the content, give a reward to the party based on the determined benefit, and provide the player with a motivation to play the video game.

In other words, it is possible to realize a mechanism in which the content is not played once and is ended, but the content is not played in the help of the player who plays the content for the first time.

In addition, in the example of the first embodiment described above, since the player who does not have the content clearing experience is specified and the benefit is determined based on the number of players who do not have the content clearing experience, the benefit can be made more expensive as the number of players who do not have the content clearing experience increases, and it becomes easier to provide the motivation for the already cleared player to play the content again.

Further, in the example of the first embodiment described above, since the benefit is determined by referring to the benefit information in which the in-game element usable in the video game and the lottery probability are associated with each other and performing the lottery the number of times corresponding to the number of players specified by the specifying function, it is possible to provide the player having the play experience of the content or the player having the clear experience of the content with a motivation to play the game so as to help a so-called beginner.

### Second Embodiment

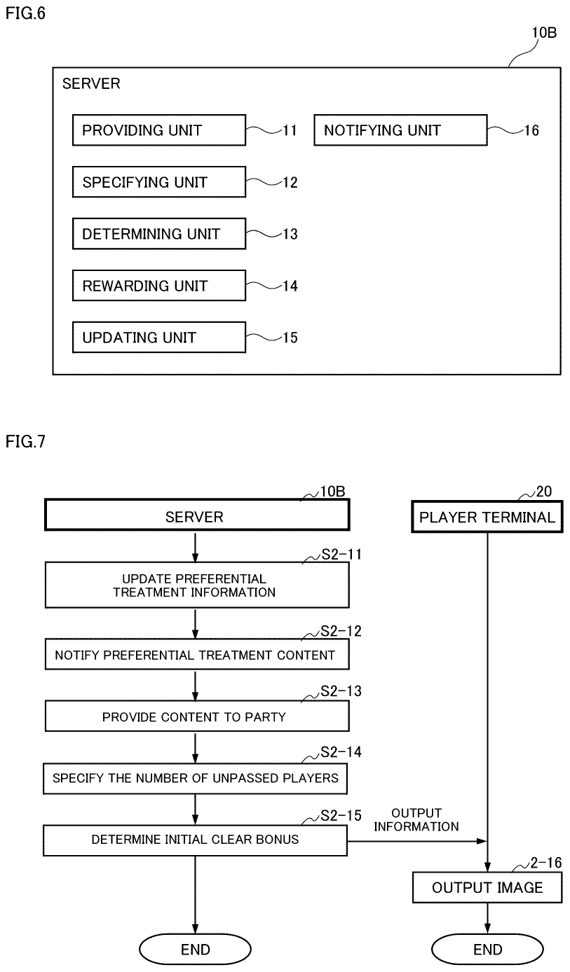

FIG. 6 is a block diagram showing a configuration of a video game processing server 10B (server 10Z) which is an example of the video game processing server 10. In the present example, the server 10B includes at least a providing unit 11, a specifying unit 12, a determining unit 13, an rewarding unit 14, an updating unit 15, and a notifying unit 16.

The update unit 15 has a function of referring to preferential treatment information in which a plurality of virtual worlds and preferential treatment contents are associated with each other, and updating the preferential treatment information in accordance with a predetermined update rule.

Here, the virtual world means a virtual space including characters of a video game. Although the configuration of the plurality of virtual worlds is not particularly limited, it is preferable that the same content can be played in each virtual world. In an example of such a configuration, one server corresponds to one virtual world. The data center may be configured to collect a plurality of virtual worlds (servers). A plurality of data centers may be provided. A user of a video game belongs to a data center (DC), selects a server, and plays content.

In addition, the preferential treatment content means a convention for preferential treatment of a player more than usual. Although the preferential treatment content is not particularly limited, it is preferable that the preferential treatment content be recognizable by the player. Examples of the preferential content include an increase in reward and an increase in item drop rate.

Furthermore, although the configuration for updating the preferential treatment information is not particularly limited, it is preferable that the configuration be a determination element for the player to select the server. In an example of such a configuration, the preferential treatment content is randomly set for each data center or server.

The notifying unit 16 has a function of notifying the player of the virtual world associated with the preferential treatment content satisfying the notification condition for the player based on the updated preferential treatment information.

Here, the notification condition is not particularly limited, but it is preferable that the notification condition can be recognized when the player selects the server. Examples of the notification condition include a predetermined period after the update and a preferential treatment occurrence period.

The configuration for notifying the player of the virtual world is not particularly limited, and a predetermined icon may be displayed on the server or the content selection screen, or each player may be notified of information on the preferential treatment server.

FIG. 7 is a flowchart showing an example of a game process corresponding to at least one of the embodiments of the present invention. Hereinafter, operations of the server 10B and the terminal 20 will be described as an example. Note that the description of the flowcharts illustrating the operations of the server 10B and the terminal 20 will be omitted from the viewpoint of avoiding redundant description.

The game process is started, for example, when the system 100B receives an operation input by the player. In the game process, the server 10B first updates the preferential treatment information (step S2-11). In this example, the preferential treatment information in this example is used to generate a reward bonus (i.e., a benefit) for several days per week. Further, it is preferable that it is difficult for the user to predict the occurrence timing of the reward bonus. At the time of occurrence, a special display is made on a predetermined UI. While the benefit is occurring, a bonus is placed on the reward. Examples of the bonus include “the number of drops of an arbitrary item increases by n” and “the drop rate of an arbitrary item increases by n%”.

Here, as a requirement of the UI, there is a case where the player can recognize that the reward bonus occurs. In this example, an icon of an item in which the number of drops of the item increases is displayed so that it is possible to know how many drops are to be dropped, and a probability-up icon is displayed (it is not necessary to describe which item drop rate is to be increased).

Further, in this example, it is assumed that whether or not the reward bonus occurs for each content can be set as a game requirement. In addition, it is assumed that the present invention is always applied when a content play is requested at the time of occurrence of the reward bonus (e.g., even when a time has passed at the time of clearing). Further, it is assumed that a predetermined time is maintained when the reward bonus occurs, and a specific cool time is provided after a predetermined time elapses from the occurrence of the reward bonus. Note that the configuration for determining the length of the cool time (that is, the time until the reward bonus is generated again) is not particularly limited, and there is a configuration in accordance with a predetermined rule or a configuration in which the length of the cool time is randomly determined. Further, the reward bonus may be generated simultaneously for all DCs after the cool time elapses. Further, a reward bonus may be forcibly generated by a tool separately from random generation. In this case, a drop table in which the reward bonus is occurring and a drop table in which the reward bonus is not occurring may be set. In addition, in the present example, it is assumed that a log message notifying an increase in the probability and an increase in the number of drops is displayed when the party starts the content.

In addition, although a method of calculating the reward bonus end time is not particularly limited, it is preferable to make the player feel randomness. In such an example, the dice are lowered according to the weighting of each DC and selected from four types of durations (e.g., 3 h/6 h/9 h/12 h). Alternatively, the cool time may be started 12 hours after the last occurrence time of the reward bonus. Further, in order to make the cool time common to all DCs, the random values 0 to 4 may be calculated using the current time as a seed.

Although the configuration for forcibly controlling the occurrence state of the bonus by the tool separately from the occurrence control in the system is not particularly limited, it is preferable that this control is performed for each DC. For example, when the tool is turned on, the reward bonus may be continuously generated until the tool is turned off. The cool-down timer may not be reset even if the tool control is performed (the cool-down continues to be counted on the back), and for example, if the tool is turned off when there is one hour left on the cooldown timer, the bonus may be configured to occur one hour later.

When the preferential treatment information is updated (step S2-11), the server 10B notifies the preferential treatment content. (Step S2-12) In this example, the server 10B displays a predetermined icon so that the player can recognize at least a part of the preferential treatment content on the content selection screen.

When notifying the preferential treatment content, the server 10B provides the content to the party (step S2-13). In the present example, the server 10B transmits information necessary for each of the players constituting the party to play the content to each terminal.

When the content is provided to the party, the server 10B specifies the number of unpassed players (step S2-14). In the present example, the server 10B specifies the number of unpassed players (i.e., the number of players having no clearing experience of content) from the player information in order to realize dropping a special item by the number of unpassed players at the time of content clearing as the initial clear bonus. More specifically, for example, in a case where 5 of 24 players constituting a party have not crossed, all the parties can obtain items five times as much as an amount normally obtained at the time of clearing. This makes it possible to expect that a cleared player will be motivated to assist an uncleared player even if the content cannot be used immediately after being released. In addition, the cleared player is likely to enter the party recruitment in which the unpassed player stands.

Here, as UI requirements, a log message may be displayed at the time of starting content, or a log message may be displayed at the time of clearing content. Further, the contents of the log message may be changed so as to convey the fact when the non-passed bonus probability is less than 100% and one or more bonus items are dropped or when the non-passed bonus probability is less than 100% and no bonus item is dropped.

After specifying the number of unpassed players, the server 10B determines an initial clear bonus (step S2-15). In this example, the server 10B is configured to be able to set the number and probability per person to be dropped in the initial clear bonus (or the unbinding bonus). For example, a plurality of types of benefits at the time of clearing may be set. In addition, the number and probability of items to be dropped may be set for one non-passing player. In this case, in the case where the probability is set, the dice corresponding to the number of people are screened (For example, when there are 10 non-passing players at 50%, the dice are sieved 10 times.). In addition, when there are five non-passing players, in general, when one drop determination becomes a reward, the drop determination may be additionally performed (That is, since a normal determination is also performed, a total of two data are dropped in this example.). In addition, an item having a value higher than that of a normal item may be additionally dropped by the number of unpassed players. Upon determining the benefit, the server 10B generates output information for causing the player terminal 20 to output the determined benefit or the reward determined from the benefit, and transmits the generated output information to the player terminal 20.

The terminal 20 displays the image based on the output information received from the server 10B (step S2-16).

As described above, as one aspect of the second embodiment, since the server 10B that controls the progress of the video game is configured to include the providing unit 11, the specifying unit 12, the determining unit 13, the giving unit 14, the updating unit 15, and the notifying unit 16, the content is provided to the party by associating the party configured by a plurality of players with the content provided in the video game, it is possible to specify at least a player who does not have the play experience of the content among the players constituting the party, determine a benefit at least on the condition of playing the content based on the number of players specified as players who do not have the play experience of the content, give a reward to the party based on the determined benefit, and provide the player with a motivation to play the video game.

In other words, it is possible to realize a mechanism in which the content is not played once and is ended, but the content is not played in the help of the player who plays the content for the first time.

In the example of the second embodiment described above, the video game includes a plurality of virtual worlds managed by a plurality of servers, and the server 10B refers to the preferential treatment information in which the plurality of virtual worlds and the preferential treatment contents are associated with each other, updates the preferential treatment information according to a predetermined update rule, and notifies the player of the virtual world associated with the preferential treatment contents satisfying the notification condition to the player based on the updated preferential treatment information, on the other hand, it is possible to prevent the players from becoming unable to gather on a specific server. In addition, for example, by adopting a configuration in which there is a reward in DC1 for event A on the premise of matching by multiple people and there is a reward in DC2 for event B on the premise of matching by multiple people, it is possible to level the game population for each DC while maintaining the ease of establishment of matching by guiding people who wish to play event A to DC1 and guiding people who wish to play event B to DC2.

In addition, in the example of the second embodiment described above, in the video game, the same content is provided in each of the plurality of virtual worlds, and the server 10B updates the preferential treatment information so that it is possible to set whether or not the preferential treatment based on the preferential treatment content occurs for each content in each virtual world, and the cool time until the preferential treatment occurs again is set after a predetermined time elapses from the occurrence of the preferential treatment, and thus, it is possible to provide the player with a chance to attempt to collect people during the bonus occurrence.

Although not particularly mentioned in the example of the second embodiment described above, the server 10B may be configured to provide the reward bonus and the initial clear bonus separately.

As described above, one or more deficiencies are solved by each embodiment of the present application. Note that the effects according to the respective embodiments are one example of a non-limiting effect or effect.

In each of the above-described embodiments, the plurality of player terminals 20 and 201 to 20N and the server 10 execute the above-described various processes in accordance with various control programs (for example, a video game process program) stored in a storage device included therein.

Further, the configuration of the system 100 is not limited to the configuration described as an example of each of the above-described embodiments, and for example, a configuration may be adopted in which a part or the whole of the processing described as the processing executed by the player terminal is executed by the server 10, or a configuration may be adopted in which a part or the whole of the processing described as the processing executed by the server 10 is executed by any of the plurality of player terminals 20 and 201 to 20N (for example, the player terminal 20). For example, in a configuration in which all of the processes described as the processes executed by the server 10 are executed by the player terminal 20, the server 10 becomes unnecessary, and various processes described above are executed by the player terminal 20 alone. In addition, a part or all of the storage unit included in the server 10 may be included in any of the plurality of player terminals 20 and 201 to 20N. That is, a part or all of the functions of one of the player terminal 20 and the server 10 in the system 100 may be included in the other one.

Further, the program may be configured to cause a single device that does not include a communication network to realize part or all of the functions described as examples of the above-described embodiments. In addition, a video game to which a part or all of the functions described as examples of the above-described embodiments are applied is not limited to a video game. That is, the present invention can be applied to metaverse, moving images, and other contents. Further, the network may be a network using distributed processing ledger technology, or may be content using NFT.

### INDUSTRIAL APPLICABILITY

According to one embodiment of the present invention, it is useful to provide a player with motivation to play a video game.

### Appendix

The above description of the embodiments describes at least the following invention so that those skilled in the art can practice the invention.
{1}

A non-transitory computer readable medium storing a video game processing program that, when executed, causes a server to perform:
by associating a party constituted by a plurality of players with content provided in the video game, providing the content to the party;
identifying at least a player who does not have a play experience of the content among players constituting the party;
determining, based on the identified number of players, a benefit that is at least subject to playing the content; and
rewarding the party based on the determined benefit.
{2}
   The non-transitory computer readable medium of {1}, wherein the program, When executed, causes the server to further perform:
   identifying a player who does not have a content clearing experience; and
   determining the benefit based on the number of players who do not have a content clearing experience.
{3}
   The non-transitory computer readable medium of {1} or {2}, wherein the program, when executed, causes the server to further perform:
   determining the benefit by making a lottery the number of times corresponding to the number of players specified by the specifying function with reference to benefit information in which in-game elements usable in the video game are associated with lottery probabilities.
{4}
   The non-transitory computer-readable medium according to any one of {1} to {3}, wherein the program, when executed, causes the server to further perform:
   by referring to preferential treatment information in which a plurality of virtual worlds and preferential treatment contents are associated with each other, updating the preferential treatment information according to a predetermined update rule; and
   notifying the player of the virtual world associated with the preferential treatment content satisfying the notification condition for the player based on the updated preferential treatment information.
{5}
   In the video game, the same content is provided in each of the plurality of virtual worlds, and the non-transitory computer readable medium of {4}, wherein when the program is executed, causes the server to further perform:
   updating the preferential treatment information so that whether or not preferential treatment based on the preferential treatment content occurs can be set for each content in each virtual world, and a cool time until the preferential treatment occurs again after a predetermined time elapses after the preferential treatment occurs is set.
{6}
   The video game processing program according to any one of {1} to {5}, wherein at least one of the functions realized by the server is realized by a user terminal capable of communicating with the server.
{7}
   A video game processing system comprising:
   a communication network;
   a server;
   a player terminal;
   one or more processors configured to:
   by associating a party constituted by a plurality of players with content provided in the video game, provide the content to the party;
   identify at least a player who does not have a play experience of the content among players constituting the party;
   determine, based on the identified number of players, a benefit that is at least subject to playing the content; and
   reward the party based on the determined benefit.
{8}
   A non-transitory computer readable medium storing a video game processing program that, when executed, causes a player terminal to perform:
   by associating a party constituted by a plurality of players with content provided in the video game, providing the content to the party;
   identifying at least a player who does not have a play experience of the content among players constituting the party;
   determining, based on the identified number of players, a benefit that is at least subject to playing the content; and
   rewarding the party based on the determined benefit.
{9}
   A video game processing method for controlling progress of a video game, comprising:
   by associating a party constituted by a plurality of players with content provided in the video game, providing the content to the party;
   identifying at least a player who does not have a play experience of the content among players constituting the party;
   determining, based on the identified number of players, a benefit that is at least subject to playing the content; and
   rewarding the party based on the determined benefit.
{10}
   A video game processing method in which a video game processing system including a communication network, a server, and a player terminal controls progress of a video game, comprising:
   by associating a party constituted by a plurality of players with content provided in the video game, providing the content to the party;
   identifying at least a player who does not have a play experience of the content among players constituting the party;
   determining, based on the identified number of players, a benefit that is at least subject to playing the content; and
   rewarding the party based on the determined benefit.

What is claimed is:

1. A non-transitory computer readable medium storing a video game processing program that, when executed, causes a server to perform:
by associating a party constituted by a plurality of players with content provided in the video game, providing the content to the party;
identifying at least a player who does not have a play experience of the content among players constituting the party;
determining, based on the identified number of players, a benefit that is at least subject to playing the content; and
rewarding the party based on the determined benefit.

2. The non-transitory computer readable medium of claim 1, wherein the program, when executed, causes the server to further perform:
identifying a player who does not have a content clearing experience; and
determining the benefit based on the number of players who do not have a content clearing experience.

3. The non-transitory computer readable medium of claim 1, wherein the program, when executed, causes the server to further perform:
determining the benefit by making a lottery the number of times corresponding to the number of players specified by the specifying function with reference to benefit information in which in-game elements usable in the video game are associated with lottery probabilities.

4. The video game comprises a plurality of virtual worlds managed by a plurality of servers respectively, and the non-transitory computer readable medium of claim 1, wherein the program, when executed, causes the server to further perform:
by referring to preferential treatment information in which a plurality of virtual worlds and preferential treatment contents are associated with each other, updating the preferential treatment information according to a predetermined update rule; and
notifying the player of the virtual world associated with the preferential treatment content satisfying the notification condition for the player based on the updated preferential treatment information.

5. In the video game, the same content is provided in each of the plurality of virtual worlds, and the non-transitory computer readable medium of claim 4, wherein the program, when executed, causes the server to further perform:
updating the preferential treatment information so that whether or not preferential treatment based on the preferential treatment content occurs can be set for each content in each virtual world, and a cool time until the preferential treatment occurs again after a predetermined time elapses after the preferential treatment occurs is set.

6. A video game processing system comprising:
a communication network;
a server;
a player terminal;
one or more processors configured to:
by associating a party constituted by a plurality of players with content provided in the video game, provide the content to the party;
identify at least a player who does not have a play experience of the content among players constituting the party;
determine, based on the identified number of players, a benefit that is at least subject to playing the content; and
reward the party based on the determined benefit.

7. A non-transitory computer readable medium storing a video game processing program that, when executed, causes a player terminal to perform:
by associating a party constituted by a plurality of players with content provided in the video game, providing the content to the party;
identifying at least a player who does not have a play experience of the content among players constituting the party;
determining, based on the identified number of players, a benefit that is at least subject to playing the content; and
rewarding the party based on the determined benefit.
